(19) United States
(12) Patent Application Publication
(10) Pub. No.: US 2026/0134724 A1
(43) Pub. Date: May 14, 2026

(54) SYSTEMS AND METHODS FOR INSPECTING A VEHICLE

(71) Applicant: Ford Global Technologies, LLC, Dearborn, MI (US)

(72) Inventors: Meghna Menon, Ypsilanti, MI (US); Krishna Bandi, Novi, MI (US); Mario Anthony Santillo, Canton, MI (US)

(73) Assignee: Ford Global Technologies, LLC, Dearborn, MI (US)

(21) Appl. No.: 18/947,731

(22) Filed: Nov. 14, 2024

(51) Int. Cl. G07C 5/00; G07C 5/08

(52) U.S. Cl. CPC G07C 5/008; G07C 5/0808; G07C 5/085

(57) ABSTRACT

A method includes receiving one or more vehicle marshalling messages from an automated vehicle as the automated vehicle moves through a marshalling environment and identifying one or more vehicle items associated with the automated vehicle to validate. The method further includes performing a quality validation of one the identified one or more vehicle items based on data from the received one or more vehicle marshalling messages, wherein the data received from one or more vehicle marshalling messages is used to determine a vehicle health associated with the one or more vehicle items.

### FIELD

The present disclosure relates to inspecting vehicles. More specifically, the present disclosure relates to inspecting vehicles in an automated vehicle marshaling (AVM) environment.

### BACKGROUND

The statements in this section merely provide background information related to the present disclosure and may not constitute prior art.

A vehicle assembly or manufacturing environment may include different testing locations or stations along a marshalled route that are configured to inspect a vehicle, such as to test, calibrate and/or verify the functionality of various components of the vehicle, including during and after the vehicle is assembled. However, because the testing is often performed on individual components in a discrete manner at specific locations along the marshalled route, it can be time consuming and also result in inefficiencies in the overall process.

The present disclosure addresses these and other issues related to inspecting a vehicle.

### SUMMARY

This section provides a general summary of the disclosure and is not a comprehensive disclosure of its full scope or all of its features.

The present disclosure provides a method comprising: receiving one or more vehicle marshalling messages from an automated vehicle as the automated vehicle moves through a marshalling environment; identifying one or more vehicle items associated with the automated vehicle to validate; and performing a quality validation of one the identified one or more vehicle items based on data from the received one or more vehicle marshalling messages, wherein the data received from one or more vehicle marshalling messages is used to determine a vehicle health associated with the one or more vehicle items; wherein performing the quality validation further comprises inferring data regarding the vehicle health associated with the one or more vehicle items using the data from the received one or more vehicle marshalling messages; wherein the data from the received one or more vehicle marshalling messages comprises data from a communication exchange of at least one of vehicle-to-infrastructure messages and infrastructure-to-vehicle messages; further comprising: determining one or more actions to be performed based on the quality validation and while the automated vehicle moves through the marshalling environment; further comprising: creating a log of data history over time of a plurality of automated vehicles traversing the marshalling environment based on the quality validation; wherein performing the quality validation comprises an on-going validation process that is communicated in real-time; and wherein performing the quality validation comprises a validation while the automated vehicle is in operation in the marshalling environment.

The present disclosure provides a system comprising: an infrastructure system configured to: transmit one or more infrastructure messages to an automated vehicle as the automated vehicle moves through a marshalling environment; receive one or more vehicle marshalling messages from the automated vehicle as the automated vehicle moves through the marshalling environment; identify one or more vehicle items associated with the automated vehicle to validate; and perform a quality validation of one the identified one or more vehicle items based on data from the received one or more vehicle marshalling messages, wherein the data received from one or more vehicle marshalling messages is used to determine a vehicle health associated with the one or more vehicle items; and the automated vehicle configured to: transmit the one or more vehicle marshalling messages to the infrastructure system; wherein the infrastructure system is further configured to: infer data regarding the vehicle health associated with the one or more vehicle items using the data from the received one or more vehicle marshalling messages as part of performing the quality validation; wherein the data from the received one or more vehicle marshalling messages comprises data from a communication exchange of at least one of vehicle-to-infrastructure messages and infrastructure-to-vehicle messages; wherein the infrastructure system is further configured to: determine one or more actions to be performed based on the quality validation and while the vehicle moves through a marshalling environment; wherein the infrastructure system is further configured to: create a log of data history over time of a plurality of automated vehicles traversing the marshalling environment based on the quality validation; wherein the infrastructure system is further configured to: perform the quality validation using an on-going validation process that is communicated in real-time; wherein the infrastructure system is further configured to: perform the quality validation using a validation process while the automated vehicle is in operation in the marshalling environment.

The present disclosure provides one or more non-transitory computer-readable media storing processor-executable instructions that, when executed by at least one processor, cause the at least one processor to: receive one or more vehicle marshalling messages from an automated vehicle as the automated vehicle moves through a marshalling environment; identify one or more vehicle items associated with the automated vehicle to validate; and perform a quality validation of one the identified one or more vehicle items based on data from the received one or more vehicle marshalling messages, wherein the data received from one or more vehicle marshalling messages is used to determine a vehicle health associated with the one or more vehicle items; wherein performing the quality validation further comprises inferring data regarding the vehicle health associated with the one or more vehicle items using the data from the received one or more vehicle marshalling messages; wherein the data from the received one or more vehicle marshalling messages comprises data from a communication exchange of at least one of vehicle-to-infrastructure messages and infrastructure-to-vehicle messages; wherein the at least one processor is further caused to: determine one or more actions to be performed based on the quality validation and while the vehicle moves through a marshalling environment; wherein the at least one processor is further caused to: create a log of data history over time of a plurality of automated vehicles traversing the marshalling environment based on the quality validation; and wherein performing the quality validation comprises an on-going validation process that is communicated in real-time while the automated vehicle is in operation in the marshalling environment.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a system for marshaling vehicles in accordance with one or more embodiments of the present disclosure;

FIG. 2 illustrates an example vehicle marshalled by the system shown in FIG. 1 in accordance with one or more embodiments of the present disclosure;

FIG. 3 illustrates an overall system for automated marshalling in accordance with one or more embodiments of the present disclosure;

FIGS. 4A and 4B illustrate vehicle marshalling messages in accordance with one or more embodiments of the present disclosure;

FIG. 5 is flowchart illustrating an example method for inspecting an automated vehicle in accordance with one or more embodiments of the present disclosure; and

FIG. 6 is a block diagram illustrating an example computer system in accordance with one or more embodiments of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

One or more herein described embodiments provide a means for vehicle inspection, particularly vehicles being marshalled within an AVM system (e.g., vehicles being assembled and marshalled using an AVM system). In one or more examples, the systems and methods enhance the inspection of the vehicles during AVM operations, such as while the vehicles are being marshalled by the AVM system. For example, the inspection of the vehicles can be performed using an ongoing inspection process instead of using specific or discrete vehicle-based automated plant marshaling inspection systems. That is, one or more embodiments determine the proper operation, installation, etc. (e.g., vehicle component and/or operation quality) of various vehicle components, systems, devices, etc. within an already established marshaling relationship that exists between an automated vehicle and an infrastructure server within a manufacturing facility. In various embodiments, as the vehicle(s) are marshalled within the AVM system, validation of vehicle dynamics and operation of various components can more easily be performed during the movement of the vehicle(s). That is, in one or more embodiments, as-built checks are performed while the vehicle maneuvers through the automated vehicle marshalling operations.

As an example, one or more herein described inspections are performed using an exchange of messages between an infrastructure server and one or more vehicles marshaled through a manufacturing facility within an AVM system, wherein information related to the proper operation of vehicle components is inferred (e.g., lighting, braking capability, battery life and management, vehicle dynamics, communication capability, etc.). The information is then evaluated, analyzed, validated, and/or informed to a cloud system and/or respective information technology systems prior to the vehicle being delivered (e.g., offered to a customer). As such, with one or more embodiments, the vehicle(s) are validated in operation, utilizing key information generated by the AVM system within messages exchanged from the infrastructure system to the vehicle(s).

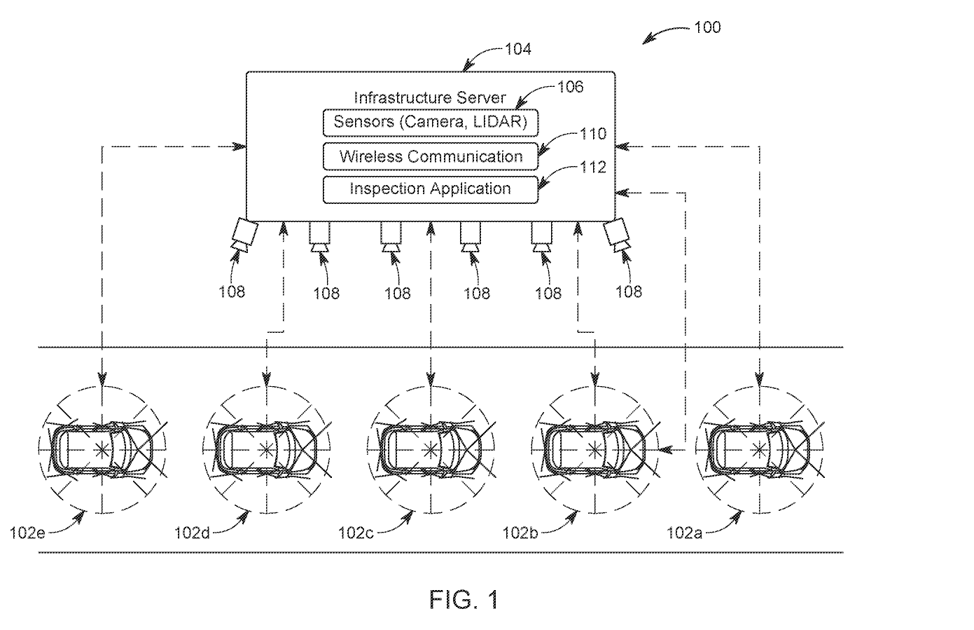

Referring now to FIG. 1, there is shown a system 100 for the marshalling of automated vehicles 102 (e.g., one or more vehicles 102a-102e) for example, situated on a factory floor, and traveling at a low speed. However, it is understood that the AVM system 100 may marshal one or more vehicles traveling at any speed. It is also understood that the AVM system 100 may marshal semi-automated vehicles and/or fully automated vehicles.

The system 100 includes an infrastructure server 104 (also referred to as the infrastructure marshalling server 104). The infrastructure server 104 further includes a sensor component 106 that communicates with a set of infrastructure sensors 108 (also referred to as the sensors 108) such as one or more sensors, for example, one or more cameras, lidar, radar, and/or ultrasonic devices. The sensors 108 monitor the movement of the vehicles 102 as the vehicles 102 move through, for example, a factory floor and/or parking lot. The infrastructure server 104 also includes a wireless communication component 110 that provides for communication between the infrastructure server 104 and the vehicles 102, as described in more detail herein. The wireless communication component 110 also communicates with the set of infrastructure sensors 108 that is configured to manage and/or include the one or more of cameras, lidar, radar, and/or ultrasonic devices.

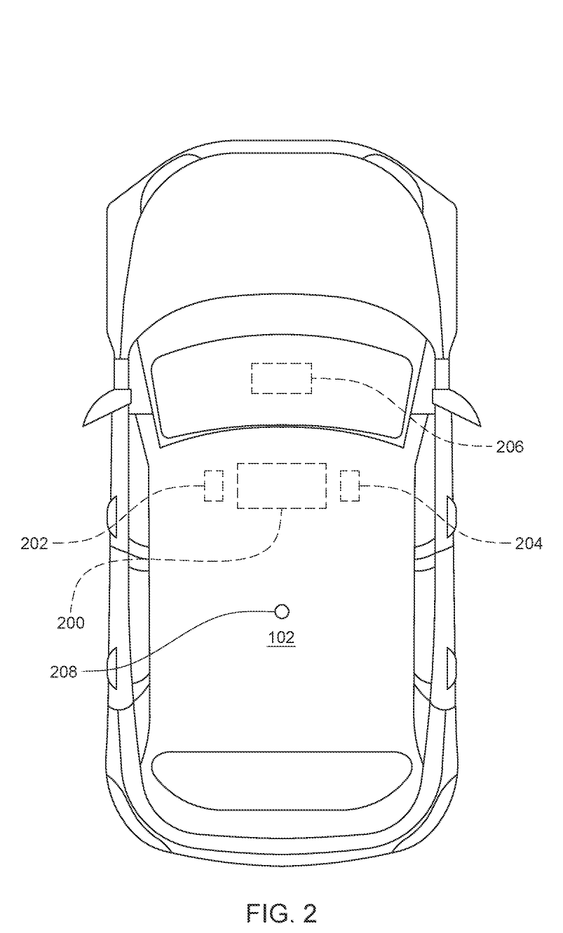

Referring additionally to FIG. 2, in various forms, the vehicles 102 are automated vehicles (and may also be referred to herein as automated vehicles 102) that may be powered in a variety of ways, for example, with an electric motor and/or an internal combustion engine. The vehicles 102 may be any type of electrically powered vehicle such as a car, a truck, a robot, a plane and/or a boat, for example. The vehicles 102 include a controller 200, one or more actuators 202, a plurality of on-board sensors 204, and a human machine interface (HMI) 206. The vehicles 102 have a reference point 208, that is, a specified point within the space defined by a vehicle body, for example, a geometrical center point at which respective longitudinal and lateral center axes of the vehicle 102 intersect. The reference point 208 identifies the location of the vehicles 102, for example, a point at which the vehicles 102 are located as the vehicles 102 navigate toward a waypoint.

The controller 200 operates the vehicles 102 in an autonomous or a semi-autonomous mode. The autonomous mode is one in which each of the propulsion, braking, and steering of the vehicles 102 are controlled by the controller 200; and in a semi-autonomous mode the controller 200 controls the propulsion, braking, and/or steering of one or two vehicles 102 with one or more of the operations partially controlled by a human operator. However, it is understood that the controller 200 may control the propulsion, braking, and/or steering of any number of vehicles 102.

The controller 200, in some examples, is configured or programmed to control the operation of one or more of vehicle brakes, propulsion (e.g., control of acceleration in the vehicle by controlling one or more of an internal combustion engine, electric motor, hybrid engine, etc.), steering, climate control, interior and/or exterior lights, etc., as well as to determine whether and when the controller 200, as opposed to a human operator, is to control such operations. Additionally, the controller 200 is programmed to determine whether and when a human operator is to control such operations.

The controller 200 includes or may be communicatively coupled to (for example, via a vehicle communications bus) one or more processors, for example, controllers or the like included in the vehicles 102 for monitoring and/or controlling various vehicle controllers, such as a powertrain controller, a brake controller, a steering controller, etc. The controller 200 is generally arranged for communications on a vehicle communication network that can include a bus in the vehicle 102 such as a controller area network (CAN) or the like, and/or other wired and/or wireless mechanisms.

Via a vehicle network, the controller 200 transmits messages to various devices in the vehicles 102 and/or receives messages from the various devices, for example, the one or more actuators 202, the HMI 206, etc. Alternatively, or additionally, in cases where the controller 200 includes multiple devices, the vehicle communication network is utilized for communications between devices represented as the controller 200 in this disclosure. Further, as discussed below, various other controllers and/or sensors provide data to the controller 200 via the vehicle communication network.

In addition, the controller 200 is configured for communicating through a wireless vehicular communication interface with other traffic objects (for example, vehicles, infrastructures, etc.), such as via a vehicle-to-vehicle communication network. The controller 200 is also configured for communicating through a vehicle-to-infrastructure communication network, such as communicating with the wireless communication component 110 of the infrastructure server 104, such as to provide inspection information relating to the vehicle(s) 102 as described in more detail herein. The vehicular communication network represents one or more mechanisms by which the controller 200 of the vehicles 102 communicate with other traffic objects, and may be one or more of wireless communication mechanisms, including any desired combination of wireless (e.g., cellular, wireless, satellite, microwave and radio frequency) communication mechanisms and any desired network topology (or topologies when multiple communication mechanisms are utilized). Examples of vehicular communication networks include, among others, cellular, CV2X-PC5, Bluetooth®, IEEE 802.11, dedicated short range communications (DSRC), and/or wide area networks (WAN), including the Internet, providing data communication services.

The vehicle actuators 202 are implemented via circuits, chips, or other electronic and/or mechanical components that can actuate various vehicle subsystems in accordance with appropriate control signals. The actuators 202 may be used to control braking, acceleration, and/or steering of the vehicles 102. The controller 200 can be programmed to actuate the vehicle actuators 202 including propulsion, steering, and/or braking based on the planned acceleration or deceleration of the vehicles 102.

The sensors 204 include a variety of devices to provide data to the controller 200. For example, the sensors 204 may include object detection sensors such as lidar sensor(s) disposed on or in the vehicles 102 that provide relative locations, sizes, and shapes of one or more targets surrounding the vehicles 102, for example, additional vehicles, bicycles, robots, people, drones, etc., travelling next to, ahead, and/or behind the vehicle 102. As another example, one or more of the sensors can be radar sensors fixed to one or more bumpers of the vehicles 102 that may provide locations of the target(s) relative to the location of each of the vehicles 102.

The object detection sensors may include a camera sensor, for example, to provide a front view, side view, rear view, etc., providing images from an area surrounding the vehicles 102. For example, the controller 200 may be programmed to receive image data from a camera sensor(s) and to implement image processing techniques to detect a road, infrastructure elements, etc. The controller 200 may be further programmed to determine a current vehicle location based on location coordinates, for example, GPS coordinates, received from the vehicles 102 and indicative of a location of the vehicles 102 from a GPS sensor.

The HMI 206 is configured to receive information from a user, such as a human operator, during operation of the vehicles 102. Moreover, the HMI 206 is configured to present information to the user, such as, an occupant of one or more of the vehicles 102. In some variations, the controller 200 is programmed to receive destination data, for example, location coordinates, from the HMI 206.

Accordingly, the vehicles 102 can be autonomously guided toward different waypoints using a combination of the infrastructure sensors 108 and the vehicle sensors (e.g., the onboard sensors 204). Routing can be done using vehicle location, distance to travel, queue in line for vehicle marshaling, etc. Vehicles 102 can be inspected using an inspection application 112 as the vehicles traverse the AVM system 100 as described in more detail herein. The movements of all of the vehicles 102 can also be coordinated through a management system that directs all traffic and logistics from an assembly plant to the waypoint.

For example, the infrastructure server 104 in one or more embodiments includes the inspection application 112 that synthesizes and leverages data communicated from the vehicles 102 to the infrastructure server 104 to infer and/or determine data regarding the vehicle’s health and quality, and ensure built vehicles 102 perform robustly. In some embodiments, an active log and data history is created over time of the vehicles 102 coming off the manufacturing line processes, which will further allow detection or identification of issues with the vehicle(s) 102 before delivery.

In one or more embodiments, the inspection application 112 is configured to receive information used to infer or generate vehicle inspection data (e.g., vehicle quality data) as the vehicles 102 are autonomously marshalled. For example, while the vehicles 102 are being marshalled, the infrastructure server 104 receives information relating to the operation, condition, etc. of one or more of vehicle lights, vehicle velocity, vehicle steering curvature, vehicle gear status, vehicle brakes, vehicle ignition, vehicle stopping behavior, vehicle process controls, vehicle horn behavior, vehicle sound acoustics behavior, vehicle lateral and longitudinal controls behavior, vehicle behavior during pitch angle, vehicle stopping distance behavior etc., which is evaluated, analyzed, validated and/or informed to, for example, a cloud system and/or respective manufacturing information technology (IT) systems prior to the vehicle 102 experiencing vehicle performance issues.

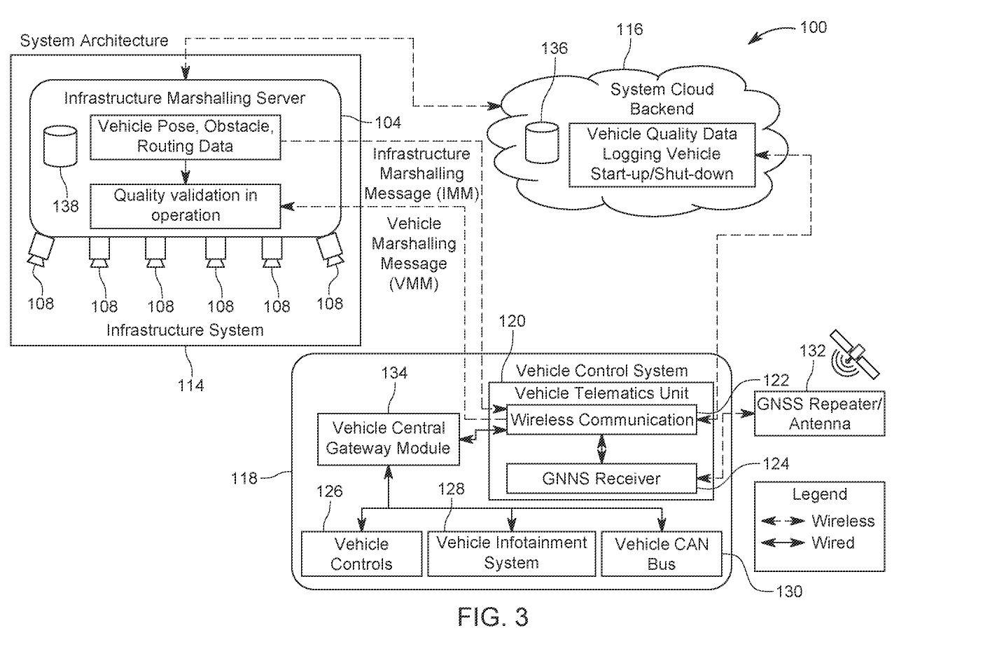

With reference now to FIG. 3, a system architecture of the system 100 in accordance with one or more embodiments is shown. As described herein, the system 100 in one or more examples is an AVM system that marshals one or more automated vehicles traveling at a low speed. However, it is understood that the system 100 may marshal one or more vehicles traveling at any speed.

The AVM system 100 generally includes an infrastructure system 114 having the infrastructure server 104 (operating as an infrastructure marshalling server), a system cloud backend 116, and a vehicle control system 118 (which may for part of or be embodied as the controller 200). The system cloud backend 116 operates as a central cloud system that manages and/or facilitates a localization and a navigation of one or more automated vehicles (e.g., the vehicles 102), such as for vehicle start-up and shut down, logs inspection data (e.g. vehicle quality data logging) in a storage device 136, etc. The system cloud backend 116 is configured to wirelessly communicate with the infrastructure system 114.

In one or more examples, the vehicle start-up and shut down controlled by the system cloud backend 116 is configured to cause one or more instructions to be sent to the vehicle control system 118, which in the illustrated example is to a wireless communication component 122 of a vehicle telematics unit 120. It should be understood that that the one or more instructions may be sent via any form of messaging, such as, but not limited to, a cellular-vehicle-to-everything (CV2X) messaging protocol, a private and/or public cellular protocol, a Wi-Fi protocol, a long range (LoRA) signal protocol, a Bluetooth protocol, and/or a UWB protocol. It should also be understood that while the one or more instructions pertain to start-up/shut-down operations associated with the vehicle 102, any type of instructions may be sent to the vehicle control system 118. That is, the vehicle control system 118 via the wireless communication component 122 is configured to wirelessly exchange (e.g., send/receive) any type of data with the system cloud backend 116, such as inspection data for vehicle quality data logging as described in more detail herein.

In operation, based on the instructions and/or data exchanged between the system cloud backend 116 and the infrastructure system 114, the automated vehicle 102 is caused to start, stop, or pause progression through the marshalling environment (e.g., an assembly facility). As another example, based on the instructions and/or data exchanged between the system cloud backend 116 and the infrastructure system 114, a marshaling speed of the automated vehicle 102 is controlled as the automated vehicle 102 traverses the marshalling environment. As a further example, the instructions and/or data exchanged between the system cloud backend 116 and the infrastructure system 114 is based on whether the automated vehicle 102 is actively turned-on or shut-down. As another example, the instructions and/or data exchanged between the system cloud backend 116 and the infrastructure system 114 is based on inspection data and/or vehicle quality data relating to the automated vehicle 102.

The infrastructure system 114 can include the wireless connectivity components, a local database 138, and the infrastructure sensors 108. The infrastructure system 114 is configured to wirelessly broadcast one or more instructions directly to the vehicle telematics unit 120 of the automated vehicle 102, such as via a CV2X protocol. However, it is understood that the infrastructure system 114 may be configured to wirelessly broadcast the one or more instructions directly to the vehicle telematics unit 120 via any form of messaging such as, but not limited to, a private and/or public cellular protocol, a Wi-Fi protocol, a long range (LoRA) signal protocol, a Bluetooth protocol, and/or a UWB protocol.

For example, the broadcasted one or more instructions may be a forwarding of the one or more instructions associated with the start-up/shut-down operations originated from the system cloud backend 116. As an example, the infrastructure system 114 may be additionally configured to wirelessly exchange (e.g., send/receive) data with the vehicle telematics unit 120 via, for example, the CV2X protocol. However, it is understood that the infrastructure system 114 may be additionally configured to wirelessly exchange data with the vehicle telematics unit 120 via any messaging means. For example, the exchanged data may be associated with the start-up/shut-down operations of the automated vehicle 102 originated from the vehicle system cloud backend 116. It is understood that while the infrastructure system 114 may utilize, for example, a dedicated short-range communications transceiver, one or more transceivers can be utilized throughout a marshaling area so that the range of communication between the infrastructure system 114 and the vehicle telematics unit 120 can be extended. As an example, the infrastructure system 114 may utilize ultra-wide band, Bluetooth^{®}, WIFI, CV2X, a public cellular network, or a private cellular network to communicate with the automated vehicle 102 (e.g., via the vehicle telematics unit 120).

The infrastructure system 114 is configured to process the one or more instructions and/or the data received from the system cloud backend 116. As an example, the one or more instructions and/or the data received from the system cloud backend 116 can be one or more various signals that can relate to anything associated with the marshaling of the automated vehicle 102, operation or condition of one or more components of the automated vehicle 102, operation or condition of one or more systems of the automated vehicles 102, etc. The infrastructure system 114 is also configured to process data received from the one or more infrastructure sensors 108, one or more sensors of the automated vehicles 102, other sensor or inspection data, etc. For example, the data received can be related to vehicle pose data, obstacle data, routing data, or a combination thereof and/or can be related to the operation or condition of one or more components or systems of the automated vehicles 102 as the automated vehicles 102 traverse the marshalling environment as described in more detail herein. It is understood, however, that the data can relate to anything associated with the marshaling of the automated vehicle 102. As can be seen, in one or more embodiments, the infrastructure marshalling server 104 receives the data, which is used for quality validation in operation as described in more detail herein.

A local database 138 (e.g., in a storage device) in one or more embodiments is a volatile memory storage component of the infrastructure system 114 that can be, but is not limited to, a random-access memory (RAM). It is understood that the local database 138 can be any type of memory and/or can be a non-volatile memory that permanently stores data. The local database 138 is configured to store any of the data and/or the one or more instructions received from the system cloud backend 116, one or more sensors, and/or the automated vehicle 102. It is understood, however, that the local database 138 can also store data associated with the marshaling of the automated vehicle 102 received from any source(s).

The infrastructure system 114 in one or more embodiments is configured to centrally control the operation of the automated vehicle 102. For example, the operation of the automated vehicle 102 includes propulsion, braking, and steering of the automated vehicle 102. For example, in a marshaling environment, the infrastructure system 114 wirelessly broadcasts a marshaling infrastructure-message to the automated vehicle 102. As another example, the marshaling infrastructure-message is broadcasted over a vehicle-to-everything (V2X) protocol. However, it is understood that any communication means may be used to broadcast the marshaling infrastructure-message.

In operation, the vehicle telematics unit 120 receives the broadcasted data and/or the one or more instructions from the infrastructure system 114, for example. The vehicle telematics unit 120, in addition to the wireless communication component 122 (e.g., a vehicle wireless connectivity interface), includes a global navigation satellite system (GNSS) receiver 124, in some examples. The vehicle wireless connectivity interface, namely the wireless communication component 110, is configured to receive one or more signals from one or more GNSS repeaters/antennas 132 via a cellular means. However, it is understood that the wireless communication component 122 may wirelessly receive the one or more signals from the one or more GNSS repeaters/antennas 132 via any messaging means. While the wireless communication component 122 is a logical interface, it is understood that the wireless communication component 122 can be any type of interface.

In one or more embodiments, the GNSS receiver 124 is communicatively coupled (e.g., wired) to the vehicle telematics unit 120 and is configured to communicate with one or more satellites (not shown) so that the vehicle control system 118 can determine a specific location of the automated vehicle 102. The GNSS receiver 124 is also configured to communicate geographical information associated with the automated vehicle 102 to the vehicle telematics unit 120. For example, the vehicle control system 118 utilizes the vehicle telematics unit 120 to process and send information received from the GNSS receiver 124 to the infrastructure system 114.

A vehicle central gateway module 134 in one or more embodiments is configured to control communications (e.g., exchange data) and/or operations of various components and/or systems of the automated vehicle 102 as described in more detail herein. For example, exchanged data may be associated with information received from any of one or more vehicle controls 126, a vehicle infotainment system 128, a vehicle CAN bus 130, or a combination thereof.

Each of the one or more vehicle controls 126, the vehicle infotainment system 128, and the vehicle CAN bus 130 can communicate with the vehicle telematics unit 120 via the vehicle central gateway module 134. The one or more vehicle controls 126 can include hybrid turbo engines, electronic engine and gearbox controls, cruise control, antilock brakes, differential braking, active and/or semi-active suspensions, or a combination thereof. However, it is understood that the one or more vehicle controls 126 can include any control-related system associated with the automated vehicle 102. For example, the vehicle control system 118 utilizes the vehicle central gateway module 134 to facilitate processing and/or send information received from the one or more vehicle controls 126 to the infrastructure system 114, via the vehicle telematics unit 120. As another example, one or more instructions are communicated to the one or more vehicle controls 126 received from the infrastructure system 114, via the vehicle telematics unit 120.

The vehicle infotainment system 128 is a system that delivers a combination of information and entertainment content and/or services to a user of the automated vehicle 102. It is understood that the vehicle infotainment system 128 can deliver information services to anyone associated with the automated vehicle 102, in other examples. As an example, the vehicle infotainment system 128 includes built-in car computers that combine one or more functions, such as digital radios, built-in cameras, and/or televisions. For example, the vehicle control system 118 utilizes the vehicle central gateway module 134 to process and/or send information received from the vehicle infotainment system 128 to the infrastructure system 114, via the vehicle telematics unit 120. As another example, the vehicle central gateway module 134 is configured to communicate one or more instructions to the vehicle infotainment system 128 received from the infrastructure system 114, via the vehicle telematics unit 120.

The vehicle CAN bus 130 communicates with the vehicle central gateway module 134 and is configured to allow any device within the network of the automated vehicle 102 to create a data frame that is transmitted, such as transmitted sequentially. For example, the vehicle CAN bus 130 is configured to prioritize further distribution of transmission received from different components within the automated vehicle 102. As another example, the vehicle CAN bus 130 organizes the transmission(s) received from the different components within the automated vehicle 102 so that a limited amount of transmitted data is distributed at a single time. While the vehicle CAN bus 130 is communicatively coupled to the vehicle central gateway module 134, it is understood that the vehicle CAN bus 130 can communicate with any number of components within the automated vehicle 102. For example, the vehicle control system 118 utilizes the vehicle central gateway module 134 to process and/or send information received from the vehicle CAN bus 130 to the infrastructure system 114, via the vehicle telematics unit 120. As another example, the vehicle central gateway module 134 is configured to communicate one or more instructions to the vehicle CAN bus 130 received from the infrastructure system 114, via the vehicle telematics unit 120.

In operation, the vehicle central gateway module 134 in one or more embodiments that is communicatively coupled (e.g., wired) to different systems and/or components of the automated vehicle 102 also collects data that is communicated to the infrastructure marshalling server 104 and used by the inspection application 112 to perform as-built checks of the different systems and/or components of the automated vehicle 102 as the automated vehicle 102 maneuvers through the automated vehicle marshalling operations. As such, using one or more methods of marshalling vehicles, various embodiments provide a robust method to ensure that the automated vehicle 102 performs automated maneuvering and control in an efficient manner, while also maintaining quality using the inspection application 112 by monitoring the health of the automated vehicle 102. For example, using information generated via exchange of over the air (OTA) messages, such as Vehicle-to-Infrastructure (V2I) and Infrastructure-to-Vehicle (I2V) messages (e.g., to and from a connected marshalling system (CMS)), one or more embodiments infer information about one or more components or operations of the automated vehicle 102 (e.g., condition or quality of lighting, braking capability, battery life and management, vehicle dynamics, communication capability, etc.). In some embodiments, a knowledge database can also then be utilized in other settings where low-speed control is evaluated, such as, but not limited to: valet parking/parking assistance features, hands-free charging, commercial warehouse/depot marshalling, parking garages, and airport parking areas, among others. That is, the herein described embodiments are not limited to automated vehicle marshalling.

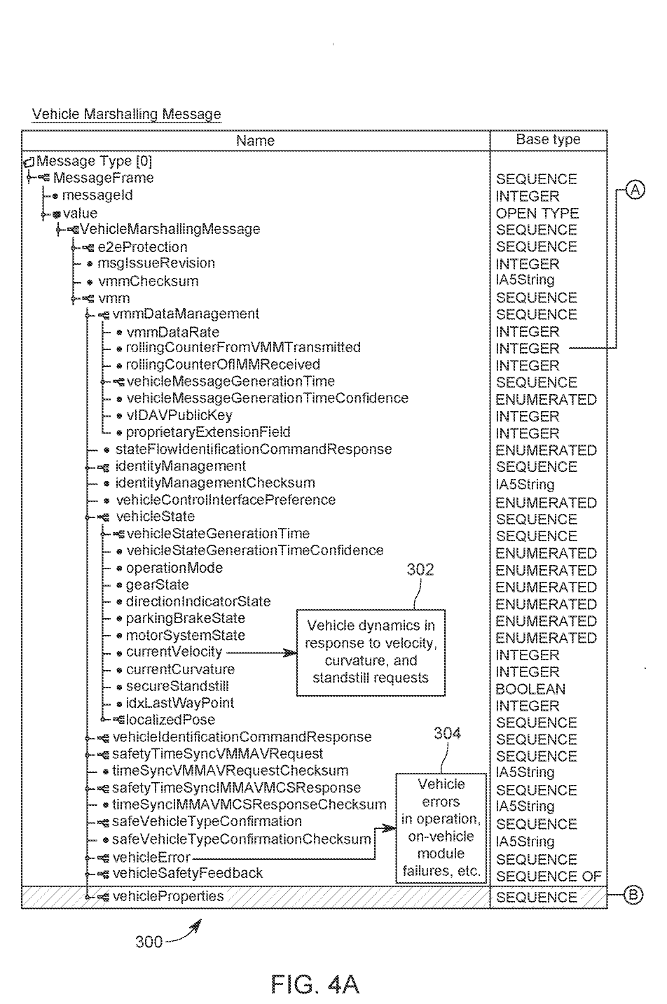

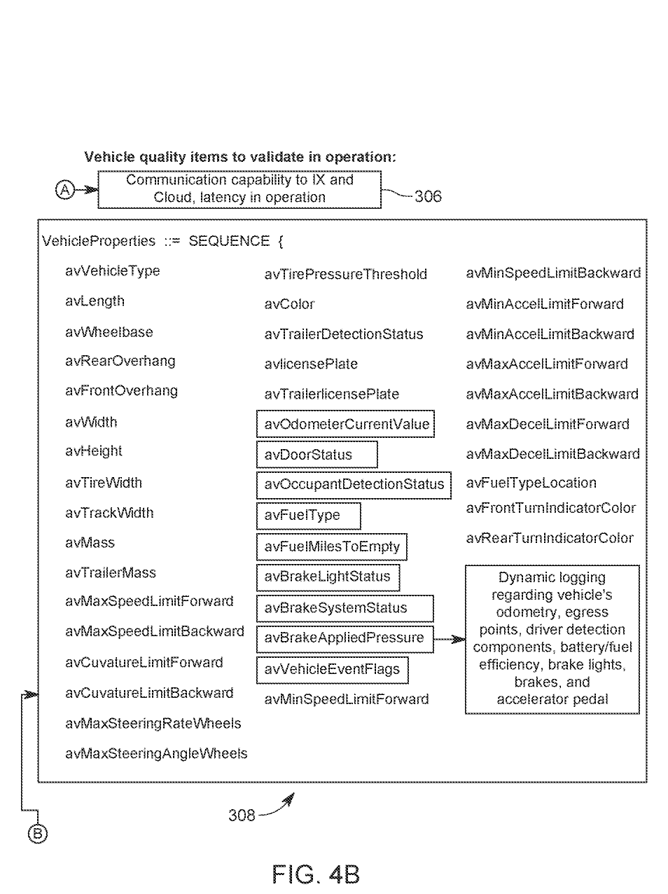

As one example, and with reference to FIGS. 4A and 4B, a vehicle marshaling message 300 is shown and that may be used in one or more embodiments. More particularly, the vehicle marshaling message 300 is a message transmitted according to an automated vehicle marshaling system standard, such as an Infrastructure Marshalling Message (IMM) that contains information used by one or more embodiments for vehicle quality evaluation, analysis, and/or validation. As can be seen, and merely for example, the vehicle marshaling message 300 includes data relating to the marshalling of the automated vehicle 102, such as vehicle dynamics data 302 in response to velocity, curvature, and standstill request; vehicle errors in operation data 304, on-vehicle module issues, etc.; and communication capability data 306 relating to communication capabilities to the infrastructure (IX) and Cloud system(s) and latency in operation. That is, IMM messages that are otherwise communicated from the automated vehicle 102 to the infrastructure system 114 are used to perform one or more quality checks, such as by the inspection application 112. It should be noted that any IMM messages and the associated data may be used in various embodiments. It should also be noted that other data is and/or can be included as part of the vehicle marshaling messages 300.

In one or more embodiments, the data provided by the vehicle marshaling message 300 is used to validate one or more vehicle quality items 308 in operation. In one example, dynamic logging is performed with respect to the received vehicle marshaling message 300 relating to the odometry, egress points, driver detection components, battery/fuel efficiency, brake lights, brakes, and accelerator pedal of the automated vehicle 102. That is, logging of data (e.g., one or more data elements) is used as part of the inspection to perform vehicle quality evaluation, analysis, and validation of the automated vehicle 102. In various examples, the vehicle marshaling message 300 allows for accessing and logging health data related to the vehicle marshaling message 300. As such, the automated vehicle 102 is inspected while the automated vehicle 102 traverses the marshalling environment using data acquired by the exchange of messages used to maneuver and operate the automated vehicle 102 in the marshaling environment.

The inspection application 112 in one or more embodiments uses the data to inspect and/or test the automated vehicle 102, such as to ensure that the automated vehicle 102 passes one or more inspections and/or realizes correct functionality for various systems of the automated vehicle 102 by inferring health and/or quality information from the data available in the vehicle marshaling message(s) 300. That is, data from the vehicle marshaling message 300 allows for ongoing validation of the automated vehicle 102 as the vehicle moves through the marshalling environment (e.g., during assembly of the automated vehicle 102). In some examples, one or more vehicle parameters, which may be dynamic parameters, are defined and used to assess the operation of the systems of the automated vehicle 102, namely to evaluate and analyze the operation of the systems to determine whether the systems are functioning as expected and/or properly. This then allows for correction of or addressing any issues while the automated vehicle 102 is being marshalled, which can reduce additional repairs, resetting of systems, etc. that have to occur before the automated vehicle 102 is delivered. For example, using one or more embodiments that allows for validation of the current behavior of the automated vehicle 102, less time may be needed for later discrete testing of the systems or components of the automated vehicle 102 and/or for diverting or stopping the automated vehicle 102 to perform the testing and/or inspection. That is, vehicle functions and/or performance of the vehicle functions can be inspected and validated, for example, as the automated vehicle 102 progresses through the manufacturing or assembly process.

Thus, in one or more embodiments, using data from vehicle marshaling messages 300, a quality of performance of the vehicle function(s) can be validated. It is understood that the quality of performance of the vehicle function(s) can correspond to any function or operation of the automated vehicle 102. In some embodiments, the data from vehicle marshaling messages 300 is used to validate the behavior or health of the automated vehicle 102, which can include operations related to features internal and/or external to the automated vehicle 102. Using one or more embodiments, the validation of certain vehicle functions is thereby not limited to particular locations within the marshalled environment (e.g., at particular testing locations within the manufacturing or assembly facility). In some embodiments, the results of the inspection and validation of the automated vehicle 102 are communicated to the automated vehicle 102. Thus, the automated vehicle 102 in some instances is able to skip or not have to perform certain testing along the marshalling route. That is, in one or more embodiments, continuous inspection and validation of the automated vehicle 102 can be performed.

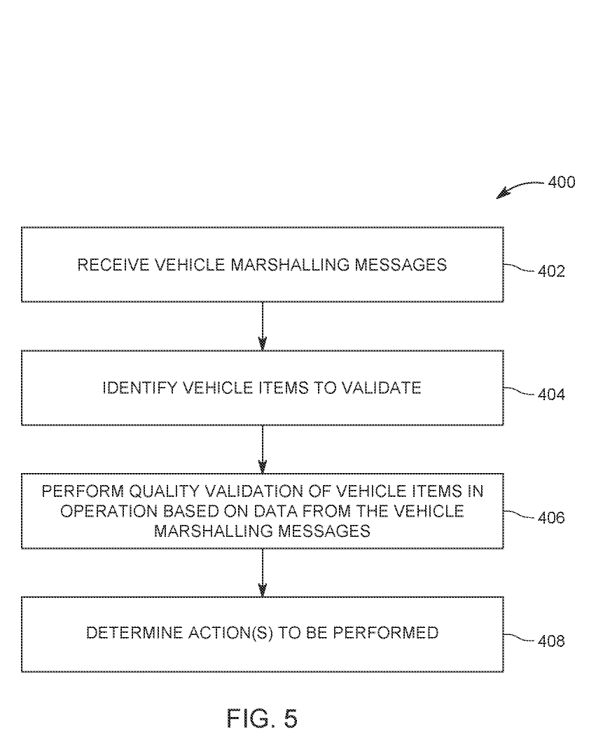

FIG. 5 is a flowchart illustrating an example method 400 for inspecting a vehicle (e.g., the automated vehicle 102). At operation 402, vehicle marshalling messages (e.g., the vehicle marshaling messages 300) are received. In one or more embodiments, the infrastructure marshalling server 104 receives the vehicle marshalling messages from one or more vehicles (e.g., one or more automated vehicles 102) as the vehicles are being marshalled within, for example, an automated vehicle manufacturing or assembly facility as described in more detail herein.

At operation 404, one or more vehicle items to validate are identified. For example, the one or more vehicle quality items 308 to be validated in operation are identified, which may be determined from the vehicle marshalling messages. That is, the vehicle items to be validated relate to the commands or instructions corresponding to the vehicle marshalling messages that are being received. As such, the items to be validated can change as the vehicle is being marshalled, for example, as different messages are exchanged between the infrastructure system 114 and the automated vehicle 102.

At operation 406, a quality validation of the vehicle items in operation is performed based on data from the vehicle marshalling messages. For example, the inspection application 112 performs quality validation based on or using data contained within the vehicle marshalling messages. In one or more embodiments, data associated or within the vehicle marshalling messages that is otherwise used for vehicle marshalling operations is used to perform the validation. For example, the inspection application 112 operates to perform quality checking by synthesizing and using data communicated to the infrastructure system 114 from the automated vehicle 102. In one or more examples, the data within the vehicle marshalling messages 300 is used to infer data regarding a health and/or operational quality of the automated vehicle 102 For example, the information received as part of the vehicle marshalling messages 300 is used to determine whether one or more systems or components of the automated vehicle 102 is operating properly. This validation may be performed using any suitable validation method, for example, that compares current operation of the one or more systems or components of the automated vehicle 102 with an expected and/or require operations of the one or more systems or components of the automated vehicle 102. That is, in one or more embodiments, using the data from the vehicle marshalling messages 300, a determination can be made whether one or more features or operations (e.g., one or more functions) of the automated vehicle 102 satisfies a desired or required quality check or quality parameter. As such, the automated vehicle 102 is inspected as the automated vehicle 102 traverses the marshalling environment, for example, by inspecting a vehicle feature, a vehicle quality, or a combination thereof. The vehicle feature can be, but is not limited to, any functional aspect of an interior of the vehicle, an exterior of the vehicle, or a combination thereof. Thus, in one or more embodiments, quality validation comprises an on-going validation process that is communicated in real-time.

At operation 408, a determination is made whether any action(s) are to be performed. For example, a determination is made based on the validation whether any remedial or corrective actions (e.g., system reset or modifications) are to be performed in order for the automated vehicle 102 to satisfy one or more checks. The remedial or corrective actions then may be performed, such as while the automated vehicle 102 is being marshalled.

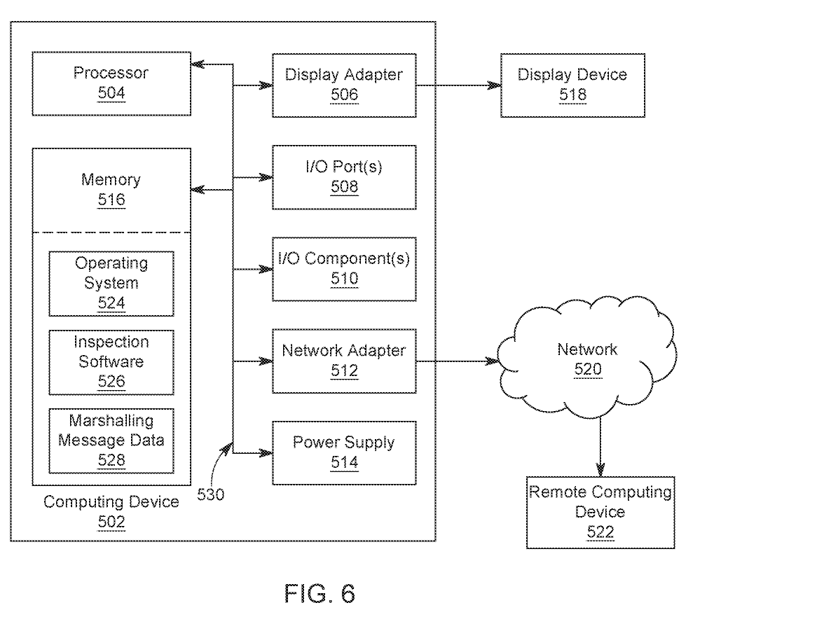

FIG. 6 illustrates an operating environment, such as a computer system, that facilitates the performance of the one or more systems and methods described herein. More specifically, the systems and methods described herein can be implemented using a computing device 502. For example, the computing device 502 can be a personal computer, a desktop, a laptop, a tablet, a hand-held computer, a server, a workstation, a mainframe, a wearable computer, a supercomputer, or a combination thereof. However, it is understood that the aforementioned examples of the computing device 502 is non-exhaustive and the computing device 502 can be any type of processing or computing device. The computing device 502 generally includes a processor 504, a display adapter 506, one or more input/output port(s) 508, one or more input/output component(s) 510, a network adapter 512, a power supply 514, and a memory 516. However, it is understood that the computing device 502 can include any additional components therein and is not required to include any of the listed components (e.g., the processor 504, the display adapter 506, the one or more input/output port(s) 508, the one or more input/output component(s) 510, the network adapter 512, the power supply 514, and the memory 516).

The processor 504 is configured to provide instructions to the computing device 502 so that the computing device 502 can process one or more tasks including the implementation of a software program to perform one or more operations as described in more detail herein. It is also understood that the computing device 502 may include any number or processors 504 therein. The display adapter 506 can be a graphics card or a video board that provides the computing device 502 with a capability to display content on a display device 518. For example, the display device 518 can be any screen, monitor, and/or light-emitting component associated with any of the personal computer, the desktop, the laptop, the tablet, the hand-held computer, the server, the workstation, the mainframe, the wearable computer, the supercomputer, or a combination thereof. However, it is understood that the aforementioned examples of the display device 518 is non-exhaustive and that the display device 518 can be any type of device capable of providing a visual display.

The input/output port(s) 508 provide a number of interfaces (e.g., sockets) for one or more cables to connect to the computing device 502. It is understood that there may be any number of input/output port(s) 508 on the computing device 502. For example, the input/output port(s) 508 provides a means for the computing device 502 to receive signals and/or data from an external device connected to the computing device 502 via the one or more cables. As another example, the input/output port(s) 508 provide a means for the computing device 502 to send signals and/or data to an external device connected to the computing device 502 via the one or more cables. The input/output component(s) 510 can include one or more components that support the input/output port(s) 508 such as, but not limited to, a switch, a push button, a pressure mat, a float switch, a keypad, a radio receive, or a combination thereof.

The network adapter 512 can be any type of network interface controller that is configured to provide a means for communicating over a network 520 with another computing device, such as a remote computing device 522. For example, the remote computing device 522 can be a user device such as a cellular-phone, a smartphone, a tablet, a laptop, or a combination thereof. The power supply 514 is configured to convert alternating high voltage current (e.g., AC) into direct current (e.g., DC) to provide power to the other components (e.g., the processor 504, the display adapter 506, the one or more input/output port(s) 508, the one or more input/output component(s) 510, the network adapter 512, and the memory 516) of the computing device 502.

Additionally, the memory 516 can be a mass storage device and/or a system memory such as a hard disk drive, a memory card, a solid-state drive, random access memory (RAM), or a combination thereof. The memory 516 is configured to provide storage for instructions and data associated with the operation of the computing device 502. The memory 516 can generally include an operating system 524, inspection software 526, and marshalling message data 528. For example, the operating system 524 is configured to manage and/or process any of the data and/or instructions associated with the inspection software 526 and/or marshalling message data 528, as described in more detail herein.

Furthermore, a system bus 530 is also included within the computing device 502 that is configured to couple each of the various components (e.g., the processor 504, the display adapter 506, the one or more input/output port(s) 508, the one or more input/output component(s) 510, the network adapter 512, the power supply 514, and the memory 516) of the computing device 502. It is also understood that each of the components of the computing device 502, and the functionality associated with each of the components of the computing device 502, may be implemented within the remote computing device 522. While the operating environment illustrated within FIG. 5 depicts a particular configuration associated with at least the computing device 502, the network 520, and the remote computing device 522, it is understood that the operating environment may be configured in any way.

Thus, one or more examples of the present disclosure provides a means for monitoring an infrastructure sensor suite and/or a vehicle sensor suite based on an exchange of one or more messages between the infrastructure sensor suite and/or the vehicle sensor suite. The present disclosure also provides a means for recalibrating the infrastructure sensor suite and/or the vehicle sensor suite based on a detection of one or more issues with either of the infrastructure sensor suite and/or the vehicle sensor suite.

Unless otherwise expressly indicated herein, all numerical values indicating mechanical/thermal properties, compositional percentages, dimensions and/or tolerances, or other characteristics are to be understood as modified by the word “about” or "approximately" in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method comprising:
receiving one or more vehicle marshalling messages from an automated vehicle as the automated vehicle moves through a marshalling environment;
identifying one or more vehicle items associated with the automated vehicle to validate; and
performing a quality validation of one the identified one or more vehicle items based on data from the received one or more vehicle marshalling messages, wherein the data received from one or more vehicle marshalling messages is used to determine a vehicle health associated with the one or more vehicle items.

2. The method of claim 1, wherein performing the quality validation further comprises inferring data regarding the vehicle health associated with the one or more vehicle items using the data from the received one or more vehicle marshalling messages.

3. The method of claim 1, wherein the data from the received one or more vehicle marshalling messages comprises data from a communication exchange of at least one of vehicle-to-infrastructure messages and infrastructure-to-vehicle messages.

4. The method of claim 1, further comprising:
determining one or more actions to be performed based on the quality validation and while the automated vehicle moves through the marshalling environment.

5. The method of claim 1, further comprising:
creating a log of data history over time of a plurality of automated vehicles traversing the marshalling environment based on the quality validation.

6. The method of claim 1, wherein performing the quality validation comprises an on-going validation process that is communicated in real-time.

7. The method of claim 1, wherein performing the quality validation comprises a validation while the automated vehicle is in operation in the marshalling environment.

8. A system comprising:
an infrastructure system configured to:
transmit one or more infrastructure messages to an automated vehicle as the automated vehicle moves through a marshalling environment;
receive one or more vehicle marshalling messages from the automated vehicle as the automated vehicle moves through the marshalling environment;
identify one or more vehicle items associated with the automated vehicle to validate; and
perform a quality validation of one the identified one or more vehicle items based on data from the received one or more vehicle marshalling messages, wherein the data received from one or more vehicle marshalling messages is used to determine a vehicle health associated with the one or more vehicle items; and
the automated vehicle configured to:
transmit the one or more vehicle marshalling messages to the infrastructure system.

9. The system of claim 8, wherein the infrastructure system is further configured to:
infer data regarding the vehicle health associated with the one or more vehicle items using the data from the received one or more vehicle marshalling messages as part of performing the quality validation.

10. The system of claim 8, wherein the data from the received one or more vehicle marshalling messages comprises data from a communication exchange of at least one of vehicle-to-infrastructure messages and infrastructure-to-vehicle messages.

11. The system of claim 8, wherein the infrastructure system is further configured to:
determine one or more actions to be performed based on the quality validation and while the vehicle moves through a marshalling environment.

12. The system of claim 8, wherein the infrastructure system is further configured to:
create a log of data history over time of a plurality of automated vehicles traversing the marshalling environment based on the quality validation.

13. The system of claim 8, wherein the infrastructure system is further configured to:
perform the quality validation using an on-going validation process that is communicated in real-time.

14. The system of claim 8, wherein the infrastructure system is further configured to:
perform the quality validation using a validation process while the automated vehicle is in operation in the marshalling environment.

15. One or more non-transitory computer-readable media storing processor-executable instructions that, when executed by at least one processor, cause the at least one processor to:
receive one or more vehicle marshalling messages from an automated vehicle as the automated vehicle moves through a marshalling environment;
identify one or more vehicle items associated with the automated vehicle to validate; and
perform a quality validation of one the identified one or more vehicle items based on data from the received one or more vehicle marshalling messages, wherein the data received from one or more vehicle marshalling messages is used to determine a vehicle health associated with the one or more vehicle items.

16. The one or more non-transitory computer-readable media of claim 15, wherein performing the quality validation further comprises inferring data regarding the vehicle health associated with the one or more vehicle items using the data from the received one or more vehicle marshalling messages.

17. The one or more non-transitory computer-readable media of claim 15, wherein the data from the received one or more vehicle marshalling messages comprises data from a communication exchange of at least one of vehicle-to-infrastructure messages and infrastructure-to-vehicle messages.

18. The one or more non-transitory computer-readable media of claim 15, wherein the at least one processor is further caused to:
determine one or more actions to be performed based on the quality validation and while the vehicle moves through a marshalling environment.

19. The one or more non-transitory computer-readable media of claim 15, wherein the at least one processor is further caused to:
create a log of data history over time of a plurality of automated vehicles traversing the marshalling environment based on the quality validation.

20. The one or more non-transitory computer-readable media of claim 15, wherein performing the quality validation comprises an on-going validation process that is communicated in real-time while the automated vehicle is in operation in the marshalling environment.
